(19) United States
(12) Patent Application Publication
(10) Pub. No.: US 2025/0305553 A1
(43) Pub. Date: Oct. 2, 2025

(54) HYDRAULIC BUMP STOP

(71) Applicant: Fox Factory, Inc., Duluth, GA (US)

(72) Inventors: Ola Christopher Nilsson, Flowery Branch, GA (US); Karl Jensen, Jefferson, GA (US)

(73) Assignee: Fox Factory, Inc., Duluth, GA (US)

(21) Appl. No.: 18/620,018

(22) Filed: Mar. 28, 2024

(51) Int. Cl. F16F 9/48; B60G 13/08; B60G 17/08; F16F 9/19; F16F 9/32; F16F 9/58

(52) U.S. Cl. CPC F16F 9/486; F16F 9/19; F16F 9/3214; F16F 9/58; B60G 13/08; B60G 17/08; B60G 2202/24; B60G 2204/62; B60G 2206/41; B60G 2500/104; B60G 2600/21; B60G 2800/162; B60G 2800/916; F16F 2222/12; F16F 2228/066; F16F 2236/04

(57) ABSTRACT

Disclosed herein is a hydraulic bump stop comprising a bump stop body comprising a chamber; a shaft telescopically engaged with the bump stop body, a piston slidably disposed with the bump stop body and coupled to a first end of the shaft, the piston comprising an orifice for fluidly connecting the chamber to an interior of the shaft, and a flow controlling element coupled to a surface of the bump stop body opposing the orifice and aligned with the orifice such that the flow controlling element enters the orifice during operation of the hydraulic bump stop, the flow controlling element having a varying geometry such that a gap between the orifice and the flow controlling element varies according to a compression of the shaft within the bump stop body, wherein a size of the gap impacts fluid flow through the orifice during operation of the hydraulic bump stop.

### BACKGROUND ART

In bike and vehicular suspension, a bump stop may be used during instances of possible suspension bottoming out. When the suspension bottoms out, or is fully compressed, the suspension and even the vehicle frame can be damaged. Bottom out events can lead to a loss of vehicle control and discomfort experienced by the vehicle occupants. Bump stops act to prevent full bottoming out, and as a result protect the suspension system and frame of the vehicle or bike. This increased bottom out control contributes to increased occupant safety and comfort.

### BRIEF DESCRIPTION OF THE DRAWINGS

The accompanying drawings, which are incorporated in and form a part of this specification, illustrate embodiments of the present technology and, together with the description, serve to explain the principles of the present technology.

FIG. 1 shows a cross section view of hydraulic bump stop in an extended position, according to an embodiment.

FIG. 2 shows a cross section view of hydraulic bump stop in substantially fully compressed position, according to an embodiment.

FIG. 3 shows a cross section view of hydraulic bump stop having a negative spring, according to an embodiment.

FIGS. 4A through 4C show examples of flow controlling elements for use within a hydraulic bump stop, according to various embodiments.

FIG. 5 shows a graph of damping force relative to displacement for a bump stop with a flow controlling element, according to embodiments.

### DETAILED DESCRIPTION OF THE EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, and objects have not been described in detail as not to unnecessarily obscure aspects of the present disclosure.

When fitting suspension and bump stop systems to a vehicle or bike, there is often a limited amount of space for the components to fit into. As a result, it is important to make the bump stop as compact as possible, while still retaining the functionality of non-compact embodiments. Hydraulic bump stops are a compromise between stroke and overall length. This has significant impact on mounting options and locations as well as tuning limitations. If dead length can be decreased, the stroke for a given compressed length can be increased, greatly improving packaging efficiency.

Due to the space constraints, current bump stop designs use orifice damping for controlling compression and rebound of the components. However, one drawback of this design is that the compression and rebound cannot be independently tuned and the impact harshness can be significant. The hydraulic damping is only speed dependent rather than position dependent. As such, users can experience very high damping forces when the suspension engages with the bump stop, resulting in an excessively harsh and severe user experience.

Embodiments described herein overcome the shortcomings of conventional bump stop by utilizing a flow controlling element (e.g., a needle) disposed within the bump stop body that provides position sensitive damping forces by controlling damping progression with valving and not gas force ramp. The described embodiments provide a flow controlling element having a varying geometry such that a gap between the orifice and the flow controlling element varies according to a compression of the shaft within the bump stop body, wherein a size of the gap impacts fluid flow through the orifice during operation of the hydraulic bump stop.

In some embodiments, as the flow controlling element fully engages with the orifice, closing the free bleed of the fluid through the orifice, the fluid is forced through compression shims on the piston. The maximum damping forces are controlled only with the shims, such that a low starting gas pressure is sufficient for damping. As such, in some embodiments, a negative spring is not required. The described embodiments provide a smooth damping ramp with low harshness.

The described embodiments provide a solution to the need for a stroke efficient external bump stop configuration where there is limited allowable packaging space. The described embodiments utilize a position sensitive damping bump stop design in which an internal flow controlling element (e.g., a needle) controls fluid flow through the orifice, providing smooth damping and reduced harshness over conventional bump stops. As the bump stop is compressed, the flow control element engages with the orifice, reducing the fluid that can flow through the orifice, providing a damping progression with valving rather than gas force.

The hydraulic bump stop described herein uses a flow controlling element to engage with an orifice of a piston, impacting the fluid bleed within the orifice to generate damping force. The damping force is a function of the geometry of the flow controlling element. In some embodiments, the flow controlling element is tapered. In other embodiments, the flow controlling element includes grooves of varying depths that vary the cross-sectional geometry for controlling a gap between the flow controlling element and the orifice. During compression, the flow controlling element enters the orifice, reducing fluid flow through the orifice to provide damping. In some embodiments, the orifice includes bushing or a coating (e.g., polytetrafluoroethylene) to reduce debris in the event of contact between the flow controlling element and the orifice.

In some embodiments, the flow controlling element includes at least one opening at the base and at least one opening at the distal end (e.g., end opposite the base) that allows for fluid flow (e.g., a center bleed). The fluid flow through the needle can be controlled, for example using a manual screw adjuster that provide rotation-based compression reduction. In some embodiments, the fluid flow can be controlled using a sensor-based activation means that can sense operational conditions for controlling damping progression.

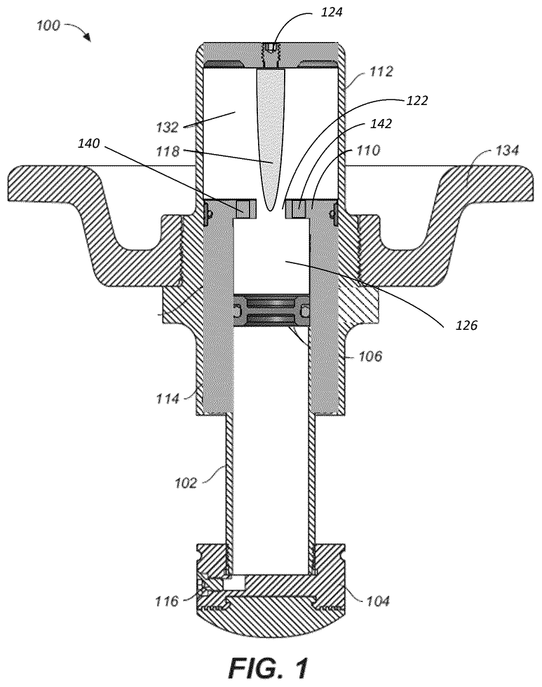

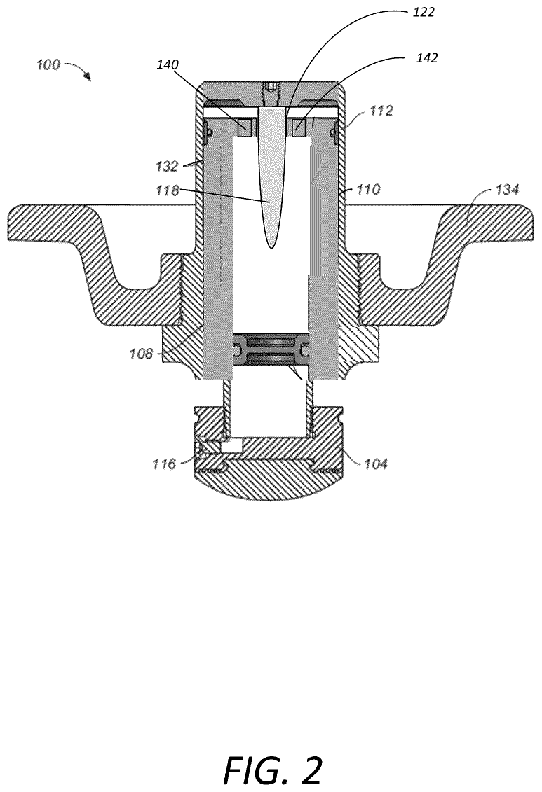

FIGS. 1 and 2 show sectional side elevation views of a hydraulic bump stop 100 in different stages of compression, according to one example embodiment. In one embodiment, the components included in bump stop 100 may be implemented a bump stop adjacent a vehicle suspension. In yet other embodiments, bump stop 100 may be implemented as a component of a vehicle suspension system where a spring component is mounted substantially in parallel with the bump stop 100.

FIG. 1 shows a cross section view of hydraulic bump stop 100, according to an embodiment. Hydraulic bump stop 100 is comprised of shaft 102, bottom bumper 104, internal floating piston 106, piston 110, mounting bracket 134, bump stop body 112, and flow controlling element 118 (also referred to herein as a “needle”). Bearing housing 114 houses the bearings, seals, and similar components. Shaft 102 is telescopically engaged with bump stop body 112, and piston 110 is slidably disposed within the bump stop body 112 and coupled to a first end of shaft 102. In some embodiments, piston 110 is threadedly coupled to the first end of shaft 102. Bottom bumper 104 is disposed at a second end of shaft 102.

The interior of shaft 102 is loaded with a gas (e.g., nitrogen). In one embodiment, gas charge 116 is in gas communication with the interior of shaft 102 through bottom bumper 104 for adding gas to the interior of shaft 102. Compression chamber 132 and rebound chamber 126 are loaded with a fluid. (e.g., oil or another hydraulic fluid). In one embodiment, the fluid is loaded into compression chamber 132 through fluid port 124.

The bump stop 100 includes a damper body 112, a shaft 102, and a piston 110 fixed on one end of the shaft 102 and mounted telescopically within the damper body 112. The outer diameter of piston 110 engages the inner diameter of damper body 112. In one embodiment, the damping liquid (e.g., hydraulic oil or other viscous damping fluid) meters from one side to the other side of the piston 110 by passing through orifice 122 formed in the piston 110. Piston 110 may also include other vented paths 140 and 142 and shims (or shim stacks) to partially obstruct the vented paths in each direction (i.e., compression or rebound). By selecting shims having certain desired stiffness characteristics, the damping effects can be increased or decreased and damping rates can be different between the compression and rebound strokes of the piston 110.

Piston 110 is slidably disposed within bump stop body 112 and divides the bump stop body 112 into compression chamber 132 and rebound chamber 126. Rebound chamber 126 is disposed within the interior of shaft 102. Compression chamber 132 is fluidly connected to rebound chamber 126 via orifice 122.

Flow controlling element 118 is disposed within compression chamber 132 of bump stop body 112 and is coupled to a surface of bump stop body 112 opposing orifice 122 and aligned with orifice 122 such that flow controlling element 118 enters orifice 122 during operation of hydraulic bump stop 100. Flow controlling element 118 has a varying geometry such that a gap between orifice 122 and flow controlling element 118 varies according to a compression of shaft 102 within the bump stop body 112, wherein a size of the gap impacts fluid flow through orifice 122 during operation of hydraulic bump stop 100.

Bump stop 100 includes an internal floating piston 106 within shaft 102 and axially movable therein. Flow controlling element 118 is fixed on one end of damper body 112 opposite shaft 102. A volume of gas is formed between internal floating piston 106 and the end of shaft 102 proximate bottom bumper 104. The gas is compressed to compensate for motion of shaft 102 into the damper body 112, which displaces a volume of damping liquid equal to the additional volume of the shaft 102 entering the damper body 112.

As shown in FIG. 1, bump stop 100 is positioned in an extended position. During operation, shaft 102 moves into and out of damper body 112, causing the damping liquid to flow from one side of the piston 110 to the other side of the piston 110 through orifice 122 within damper body 112. FIG. 1 shows flow controlling element 118 as it engages with piston 110 by entering orifice 122. As flow controlling element 118 engages with and moves within orifice 122, the size of a gap between flow controlling element 118 and orifice 122 varies according to the geometry of flow controlling element 118. The available area through which fluid can flow between compression chamber 132 and rebound chamber 126 is changed depending on the position of flow controlling element 118, thereby changing the damping pressure of bump stop 100.

During operation of hydraulic bump stop 100, compression and rebound events occur during instances of possible suspension bottoming out. A compression event occurs when a vehicle suspension makes contact with bottom bumper 104 and compresses shaft 102 into bump stop body 112. During a compression event, the overall length of hydraulic bump stop 100 is reduced, as shaft 102 slides into bump stop body 112. During a compression event, hydraulic fluid flows through orifice 122 from compression chamber 132 into rebound chamber 126.

A rebound event occurs when the suspension or object contacting bottom bumper 104 moves away from bottom bumper 104, allowing shaft 102 to extend out of bump stop body 112. During a rebound event, the overall length of hydraulic bump stop 100 increases, as shaft 102 slides out of bump stop body 112. During a rebound event, hydraulic fluid flows through orifice 122 from rebound chamber 126 into compression chamber 132.

In order to prevent the components of bump stop 100 from “bottoming out,” potentially damaging the components, the damping force resisting further compression of the bump stop 100 is substantially increased during compression. Flow controlling element 118 operates to change the area of orifice 122 through which fluid can flow, thereby changing the damping force opposing further compression of the bump stop 100. Fluid passes through orifice 122 around flow controlling element 118.

As shown in FIG. 1, flow controlling element 118 is partially within orifice 122. During compression, flow controlling element 118 moves through orifice 122 towards internal floating piston 106, and fluid flows through orifice 122 from rebound chamber 126 to compression chamber 132 and around flow controlling element 118. The amount of annular clearance (e.g., the gap) between the exterior surface of flow controlling element 118 and the surface of orifice 122 determines the damping rate caused by flow controlling element 118 entering piston 110. During a compression event, the annular clearance between the exterior surface of flow controlling element 118 and the surface of orifice 122 decreases, allowing less fluid to flow through orifice 122, and increasing the damping rate caused by flow controlling element 118 entering piston 110. In one embodiment, flow controlling element 118 is tapered to provide varying cross-sectional geometries relative to the area of orifice 122.

During a rebound event, fluid pressure bump stop 100 is reduced as flow controlling element 118 is retracted and fluid flows through orifice 122 from compression chamber 132 to rebound chamber 126 and around flow controlling element 118. During a rebound event, the annular clearance between the exterior surface of flow controlling element 118 and the surface of orifice 122 increases, allowing more fluid to flow through orifice 122, and decreasing the damping rate caused by flow controlling element 118 entering piston 110.

FIG. 2 shows a cross section view of hydraulic bump stop 100 in a substantially fully compressed position, according to an embodiment. As shown in FIG. 2, flow controlling element 118 is fully engaged within orifice 122, completely cutting off fluid flow through orifice 122. When the free bleed of fluid through orifice 122 is cut off, the fluid is forced through compression shims on the piston within at least one of vented paths 140 and 142 (also referred to herein as compression ports or rebound ports). During a substantially fully compressed position, maximum damping forces are controlled only with the shims, such that a low starting gas pressure is sufficient for damping. By selecting shims having certain desired stiffness characteristics, the damping effects can be increased or decreased and damping rates can be different between the compression and rebound strokes of the piston 110.

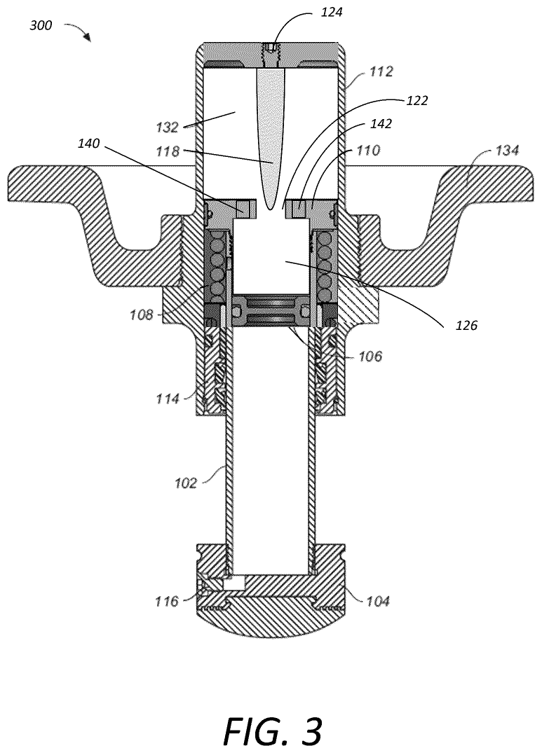

FIG. 3 shows a cross section view of hydraulic bump stop 300 having a negative spring 108, according to an embodiment. It should be appreciated that bump stop 300 operates in substantially the same manner, and includes the components of, bump stop 100 of FIGS. 1 and 2, with the sole exception of also including negative spring 108. Negative spring 108 is disposed between shaft 102 and damper body 112. It should be appreciated that negative spring 108 may include any number of coils in order to control dead length. Dead length is the length of hydraulic bump stop 100 that does not contribute to active damper travel.

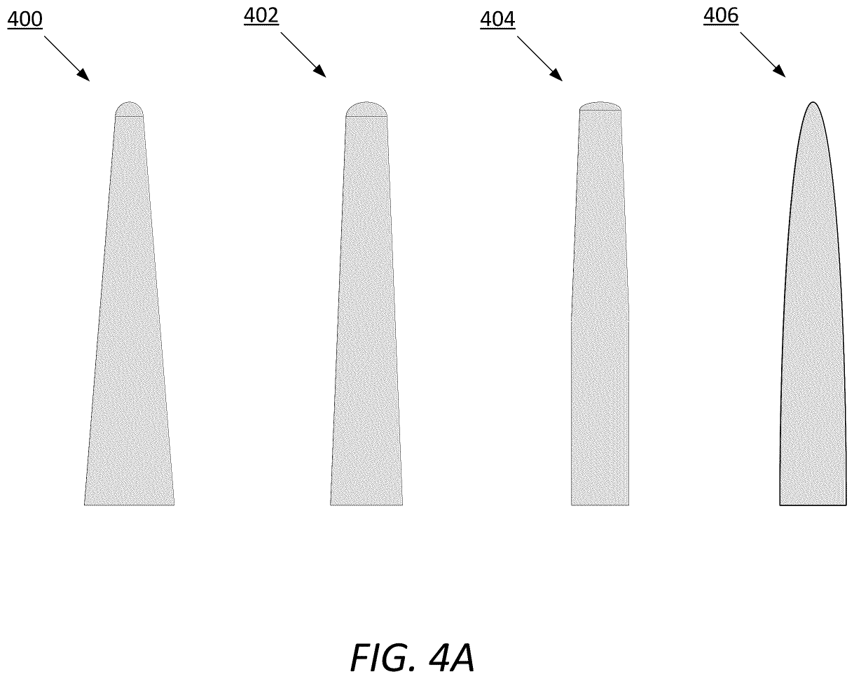

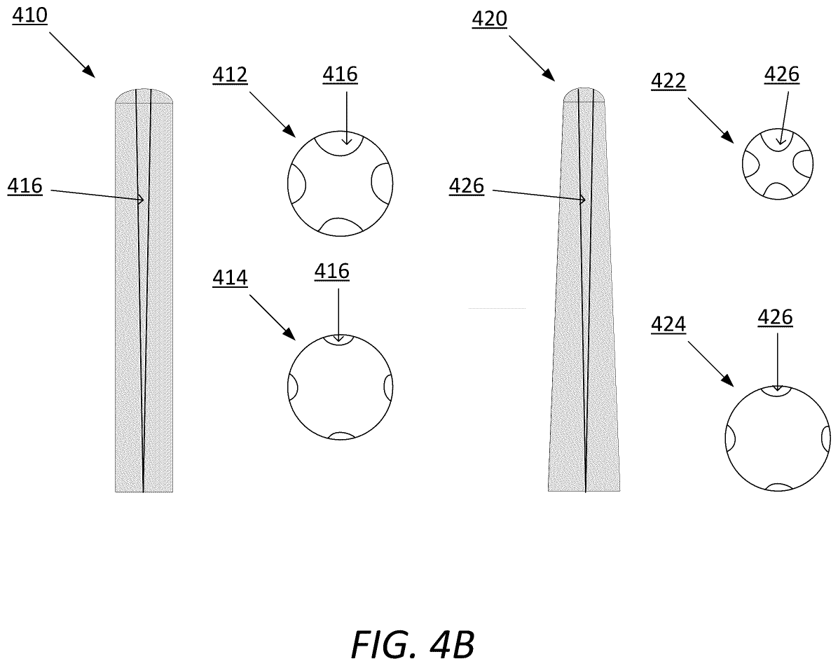

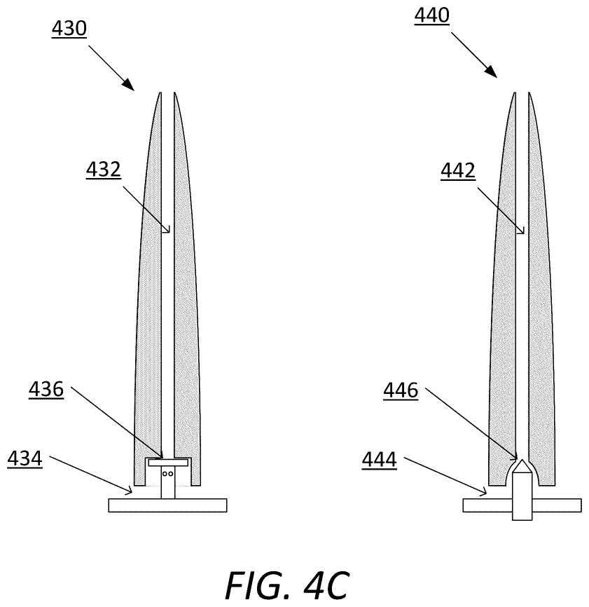

FIGS. 4A through 4C show examples of flow controlling elements for use within a hydraulic bump stop, according to various embodiments. The flow controlling elements of the described embodiments have varying geometries such that a gap between the flow controlling element and the orifice through which it engages varies according to a compression of the shaft within the bump stop body. A size of the gap between the flow controlling element and the orifice impacts fluid flow through the orifice during operation of the hydraulic bump stop.

The damping force is a function of the geometry of the flow controlling element. In some embodiments, the flow controlling element is tapered. In other embodiments, the flow controlling element includes grooves of varying depths that vary the cross-sectional geometry for controlling a gap between the flow controlling element and the orifice. During compression, the flow controlling element enters the orifice, reducing fluid flow through the orifice to provide damping. In some embodiments, the orifice includes bushing or a coating (e.g., polytetrafluoroethylene) to reduce debris in the event of contact between the flow controlling element and the orifice.

FIG. 4A illustrates examples of flow controlling elements for use within a hydraulic bump stop that are at least partially tapered, according to various embodiments. Flow controlling element 400 has a conical shape and a rounded tip, such that the circular cross-sectional shape varies linearly along the length of flow controlling element 400. Flow controlling element 402 also has a conical shape and a rounded tip, but is steeper than flow controlling element 400. Flow controlling element 404 has a lower portion that is cylindrical (e.g., the cross-sectional shape does not vary) and an upper portion that is tapered and has a rounded tip. Flow controlling element 406 has semi-ellipsoid shape, such that the circular cross-sectional shape varies non-linearly along the length of flow controlling element 406. It should be appreciated that many different types of at least partially tapered shapes can be used for flow controlling elements in accordance with the described embodiments, of which flow controlling elements 400, 402, 404, and 406 are examples.

FIG. 4B illustrates examples of flow controlling elements for use within a hydraulic bump stop that include grooves of varying depths that vary the cross-sectional geometry for controlling a gap between the flow controlling element and the orifice, according to various embodiments. Flow controlling element 410 has a cylindrical solid shape and a rounded tip, with grooves 416 of varying depth therein. Cross-section 412 shows a cross-sectional view of flow controlling element 410 closer to the tip and cross-section 414 shows a cross-sectional view of flow controlling element 410 closer to the base of flow controlling element 410. As shown, the depth of grooves 416 at cross-section 412 is deeper, and grooves 416 are bigger, than at cross-section 414. The cross-sectional area of flow controlling element 410 is smaller closer to the tip, and increases towards the base. As such, during operation within a bump stop, fluid flow decreases as flow controlling element 410 enters an orifice of a piston and continues engaging with the orifice, increasing the pressure.

Flow controlling element 420 has a conical shape and a rounded tip, with grooves 426 of varying depth therein. Cross-section 422 shows a cross-sectional view of flow controlling element 420 closer to the tip and cross-section 424 shows a cross-sectional view of flow controlling element 420 closer to the base of flow controlling element 420. As shown, the depth of grooves 426 at cross-section 422 is deeper, and grooves 426 are bigger, than at cross-section 424. The cross-sectional area of flow controlling element 420 is smaller closer to the tip, and increases towards the base. As such, during operation within a bump stop, fluid flow decreases as flow controlling element 420 enters an orifice of a piston and continues engaging with the orifice, increasing the pressure.

It should be appreciated that many different types of flow controlling elements including grooves of varying sizes and/or depths can be used in accordance with the described embodiments, of which flow controlling elements 410 and 420 are examples. For example, the flow controlling elements can have different shapes, different numbers of grooves, etc.

FIG. 4C illustrates examples of flow controlling elements for use within a hydraulic bump stop that include at least one opening through which flow can flow, according to various embodiments. The example flow controlling elements of FIG. 4C allow for fluid to flow between a compression chamber (e.g., compression chamber 132) and a rebound chamber (e.g., rebound chamber 126) during compression and rebound events.

Flow controlling element 430 has an elliptical solid shape and an opening 432 therethrough, with an opening 434 at the base that allows fluid to flow through flow controlling element 430. The fluid flow through the needle can be controlled using valve 436, which is adjustable for controlling the size of an opening for receiving fluid. Valve 436 may be, for example, a manual screw adjuster that provides rotation-based compression reduction.

Flow controlling element 440 has an elliptical solid shape and an opening 442 therethrough, with an opening 444 at the base that allows fluid to flow through flow controlling element 440. The fluid flow through the needle can be controlled using valve 446, which is adjustable for controlling the size of an opening for receiving fluid. Valve 446 may be, for example, a sensor-based activation means that can sense operational conditions for controlling damping progression. It should be appreciated that many different types of flow controlling elements including valves and openings therein can be used in accordance with the described embodiments, of which flow controlling elements 430 and 440 are examples.

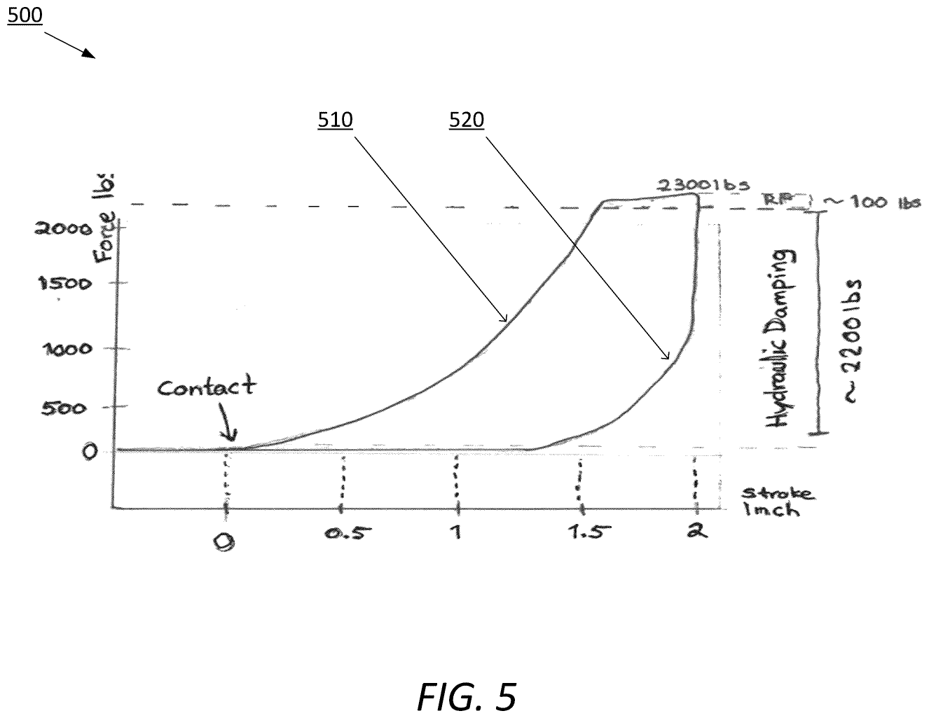

FIG. 5 shows a graph 500 of an example damping force relative to displacement for a bump stop with a flow controlling element, according to embodiments. As illustrated in FIG. 5, curve 510 shows a compression event and curve 520 shows the accompanying rebound event. Contact as made at stroke inch zero of curve 510, and hydraulic damping ramps up at a substantially smooth rate that does not exhibit any sudden force (e.g., is not harsh) until maximum displacement is reached. On the rebound stroke, of curve 520, hydraulic damping reduces at a steeper rate than the compression event, noting that the rebound event typically does not impact the user as there is separation between the bump stop and the vehicle suspension. It should be appreciated that graph 500 is an example of force and displacement for a bump stop including a flow controlling element of the described embodiments. For a similar bump stop not including a flow controlling element as described herein, a compression event would exhibit a much steeper hydraulic damping curve, causing a harsh experience for a user.

While discussed in the context of a hydraulic bump stop, the listed improvements of the above embodiments are universal enough to be used in other applications. For example, embodiments described herein may be used in a shock absorber.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments can be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What we claim is:

1. A hydraulic bump stop comprising:
a bump stop body comprising a chamber; and
a shaft telescopically engaged with the bump stop body;
a piston slidably disposed with the bump stop body and coupled to a first end of the shaft, the piston comprising an orifice for fluidly connecting the chamber to an interior of the shaft; and
a flow controlling element coupled to a surface of the bump stop body opposing the orifice and aligned with the orifice such that the flow controlling element enters the orifice during operation of the hydraulic bump stop, the flow controlling element having a varying geometry such that a gap between the orifice and the flow controlling element varies according to a compression of the shaft within the bump stop body, wherein a size of the gap impacts fluid flow through the orifice during operation of the hydraulic bump stop.

2. The hydraulic bump stop of claim 1, wherein the flow controlling element has a tapered needle geometry.

3. The hydraulic bump stop of claim 1, wherein the flow controlling element comprises a cylindrical geometry comprising grooves of varying size forming the varying geometry.

4. The hydraulic bump stop of claim 1, wherein the piston further has at least one compression port therethrough comprising a shim stack for restricting fluid flow during a compression event.

5. The hydraulic bump stop of claim 4, wherein the flow controlling element has a geometry such that during a compression event the flow controlling element can fully restrict fluid flow through the orifice, such that fluid flows through the at least one compression port during a complete orifice restriction during a compression event.

6. The hydraulic bump stop of claim 1, wherein the piston further has at least one rebound port therethrough comprising a shim stack for restricting fluid flow during a rebound event.

7. The hydraulic bump stop of claim 6, wherein the flow controlling element has a geometry such that during a rebound event the flow controlling element can fully restrict fluid flow through the orifice, such that fluid flows through the at least one rebound port during a complete orifice restriction during a rebound event.

8. The hydraulic bump stop of claim 1, further comprising a bumper disposed at a second end of the shaft.

9. The hydraulic bump stop of claim 1, further comprising:
an internal piston slidably disposed within the shaft.

10. The hydraulic bump stop of claim 1, further comprising:
a negative spring disposed between the shaft and the bump stop body.

11. The hydraulic bump stop of claim 1, further comprising:
a bushing inside the orifice to impact debris generation if there is contact between the flow controlling element and the orifice.

12. The hydraulic bump stop of claim 1, wherein the flow controlling element further comprises at least one opening therein for supporting fluid flow through the flow controlling element.

13. The hydraulic bump stop of claim 12, wherein a size of the at least one opening is tunable.

14. A hydraulic bump stop comprising:
a bump stop body comprising a chamber;
a shaft telescopically engaged with the bump stop body;
an internal piston slidably disposed within the shaft;
a piston slidably disposed with the bump stop body and coupled to a first end of the shaft, the piston comprising an orifice for fluidly connecting the chamber to an interior of the shaft and at least one compression port therethrough comprising a shim stack for restricting fluid flow during a compression event; and
a flow controlling element coupled to a surface of the bump stop body opposing the orifice and aligned with the orifice such that the flow controlling element enters the orifice during operation of the hydraulic bump stop, the flow controlling element having a varying geometry such that a gap between the orifice and the flow controlling element varies according to a compression of the shaft within the bump stop body, wherein a size of the gap impacts fluid flow through the orifice during operation of the hydraulic bump stop, and wherein the flow controlling element has a geometry such that during a compression event the flow controlling element can fully restrict fluid flow through the orifice, such that fluid flows through the at least one compression port during a complete orifice restriction during a compression event.

15. The hydraulic bump stop of claim 14, wherein the flow controlling element has a tapered needle geometry.

16. The hydraulic bump stop of claim 14, wherein the flow controlling element comprises a cylindrical geometry comprising grooves of varying size forming the varying geometry.

17. The hydraulic bump stop of claim 14, wherein the piston further has at least one rebound port therethrough comprising a shim stack for restricting fluid flow during a rebound event.

18. The hydraulic bump stop of claim 17, wherein the flow controlling element has a geometry such that during a rebound event the flow controlling element can fully restrict fluid flow through the orifice, such that fluid flows through the at least one rebound port during a complete orifice restriction during a rebound event.

19. The hydraulic bump stop of claim 14, further comprising a bumper disposed at a second end of the shaft.

20. A hydraulic bump stop comprising:
a bump stop body comprising a chamber;
a shaft telescopically engaged with the bump stop body;
an internal piston slidably disposed within the shaft;
a piston slidably disposed with the bump stop body and coupled to a first end of the shaft, the piston comprising an orifice for fluidly connecting the chamber to an interior of the shaft and at least one compression port therethrough comprising a shim stack for restricting fluid flow during a compression event;
a bumper disposed at a second end of the shaft; and
a needle having a tapered geometry coupled to a surface of the bump stop body opposing the orifice and aligned with the orifice such that the needle enters the orifice during operation of the hydraulic bump stop, the needle having a varying geometry such that a gap between the orifice and the needle varies according to a compression of the shaft within the bump stop body, wherein a size of the gap impacts fluid flow through the orifice during operation of the hydraulic bump stop, and wherein the needle has a geometry such that during a compression event the needle can fully restrict fluid flow through the orifice, such that fluid flows through the at least one compression port during a complete orifice restriction during a compression event.
